(19) United States
(12) Patent Application Publication
(10) Pub. No.: US 2016/0002066 A1
(43) Pub. Date: Jan. 7, 2016

(54) WATER TREATMENT APPARATUS AND WATER TREATMENT METHOD USING THE SAME

(71) Applicant: SUMITOMO ELECTRIC INDUSTRIES, LTD., Osaka-shi, Osaka (JP)

(72) Inventors: Makoto NISHIKAWA, Osaka-shi (JP); Hideki KASHIHARA, Osaka-shi (JP)

(21) Appl. No.: 14/768,861

(22) PCT Filed: Nov. 13, 2014
(86) PCT No.: PCT/JP2014/080035

§ 371 Date: Aug. 19, 2015

(30) Foreign Application Priority Data
Nov. 29, 2013 (JP) 2013-248720

(51) Int. Cl. C02F 1/28

(52) U.S. Cl. CPC C02F 1/28; C02F 2101/32

(57) ABSTRACT

A water treatment apparatus is a water treatment apparatus including a cylindrical main body placed in a substantially perpendicular direction; a plurality of treatment layers disposed at intervals and in an axial direction in the main body, each of the plurality of treatment layers having particles contained therein and having a pair of partition plates for preventing upward and downward outflow of the particles; an air bubble supplying portion for supplying an air bubble into the main body from below; a backwash water supplying portion for supplying backwash water into the main body from below; and a discharge portion disposed above each treatment layer in the main body, for discharging at least one of the air bubble and the backwash water, wherein a space portion is provided between an upper partition plate and the particles of the treatment layer in a steady state.

### TECHNICAL FIELD

The present invention relates to a water treatment apparatus and a water treatment method using the same.

### BACKGROUND ART

From the perspective of environmental conservation, an oil-water mixture liquid including an oil and a suspended substance generated in an oilfield, a factory and the like needs to be discarded after a mixing amount of an oil droplet, a suspended substance particle and the like is reduced to a certain value or smaller. Examples of a method for separating and removing the oil droplet, the suspended substance particle and the like from the mixture liquid include gravitational separation, separation by distillation, separation by a chemical agent, and the like. An example of a method for separating and removing the oil droplet, the suspended substance particle and the like at low cost includes a method for filtering the oil-water mixture liquid in a treatment tank having a particle contained therein.

A water treatment apparatus using the aforementioned treatment layer separates the oil droplet, the suspended substance particle and the like of the oil-water mixture liquid through filtration by using the particle in the treatment layer, and discharges the water from which these are removed (refer to Japanese Patent Laying-Open No. 5-154309).

### CITATION LIST

### Patent Document

PTD Japanese Patent Laying-Open No. 5-154309

### SUMMARY OF INVENTION

### Technical Problem

The aforementioned conventional water treatment apparatus can be suitably used for separation of the oil droplet, the suspended substance particle and the like of the oil-water mixture liquid. However, as an amount of filtered oil-water mixture liquid increases, the separated oil droplet, suspended substance particle and the like are accumulated in a space between the particles, which results in decrease in filtration efficiency. Therefore, the particle must be periodically taken out and cleaned, which is inconvenient.

The present invention has been made in view of the aforementioned circumstances, and an object of the present invention is to provide a water treatment apparatus and a cleaning method that can clean a particle easily and reliably, and consequently have an excellent water treatment efficiency.

### Solution to Problem

The invention made to solve the aforementioned problem is directed to a water treatment apparatus including a cylindrical main body placed in a substantially perpendicular direction, the water treatment apparatus purifying a liquid to be treated supplied from above through the use of a treatment portion filled into at least a part of the main body, and recovering a treated liquid from below, the water treatment apparatus including: a plurality of treatment layers disposed at intervals and in an axial direction in the main body, each of the plurality of treatment layers having particles contained therein and having a pair of partition plates for preventing upward and downward outflow of the particles; an air bubble supplying portion for supplying an air bubble into the main body from below; a backwash water supplying portion for supplying backwash water into the main body from below; and a discharge portion disposed above each treatment layer in the main body, for discharging at least one of the air bubble and the backwash water, wherein a space portion is provided between an upper partition plate and the particles of the treatment layer in a steady state.

Another invention made to solve the aforementioned problem is directed to a water treatment method having a step of supplying a liquid to be treated to the water treatment apparatus, and recovering a treated liquid.

### Advantageous Effects of Invention

The water treatment apparatus and the water treatment method according to the present invention can clean a particle easily and reliably, and consequently have an excellent water treatment efficiency.

### BRIEF DESCRIPTION OF DRAWINGS

FIG. 1 is a schematic end view showing a water treatment apparatus according to one embodiment of the present invention.

FIG. 2A is a schematic end view showing a state in which a gas supplying device is supplying an air bubble in the water treatment apparatus of FIG. 1.

FIG. 2B is a schematic end view showing a state in which a backwash water supplying device is supplying backwash water in the water treatment apparatus of FIG. 1.

FIG. 3 is a transition diagram of a differential pressure between an upper part and a lower part of a second treatment layer in Example.

### DESCRIPTION OF EMBODIMENTS

### Description of Embodiment of the Present Invention

In order to solve the aforementioned problem, the inventors of the present invention found that, by containing a particle such that a certain space is provided between a pair of partition plates retaining the particle, and supplying an air bubble and backwash water to the particle, the particle can be cleaned easily and reliably.

Specifically, the present invention is directed to a water treatment apparatus including a cylindrical main body placed in a substantially perpendicular direction, the water treatment apparatus purifying a liquid to be treated supplied from above through the use of a treatment portion filled into at least a part of the main body, and recovering a treated liquid from below, the water treatment apparatus including: a plurality of treatment layers disposed at intervals and in an axial direction in the main body, each of the plurality of treatment layers having particles contained therein and having a pair of partition plates for preventing upward and downward outflow of the particles; an air bubble supplying portion for supplying an air bubble into the main body from below; a backwash water supplying portion for supplying backwash water into the main body from below; and a discharge portion disposed above each treatment layer in the main body, for discharging at least one of the air bubble and the backwash water, wherein a space portion is provided between an upper partition plate and the particles of the treatment layer in a steady state.

The water treatment apparatus has the space portion between the upper partition plate and the particles of the treatment layer. As a result, when the air bubble and the backwash water are supplied to the particles, the particles in the liquid are stirred and the particles are diffused into the liquid, which makes it easier to separate an oil droplet, a suspended substance particle and the like having adhered to the particles. In addition, by the backwash water supplied from below, the oil droplet, the suspended substance particle and the like separated from the particles can be discharged without adhering to the other treatment layers. As a result of these, the particles can be cleaned easily and reliably by the air bubble and the backwash water, and thus, the water treatment efficiency is enhanced. It is noted that the steady state refers to a state in which the liquid to be treated is being supplied to the water treatment apparatus and the liquid to be treated is being purified.

During cleaning in the treatment layer, supply of the air bubble by the air bubble supplying portion and supply of the backwash water by the backwash water supplying portion may be repeated, and the air bubble and the backwash water may be discharged from the discharge portion located directly above the treatment layer. Since supply of the air bubble by the air bubble supplying portion and supply of the backwash water by the backwash water supplying portion are repeated as described above, the oil droplet, the suspended substance particle and the like having adhered to the particles are sufficiently separated. Since the air bubble and the backwash water are discharged from the discharge portion located directly above the treatment layer, the separated oil droplet, suspended substance particle and the like become difficult to adhere to the other treatment layers, and thus, the particles can be cleaned more easily and reliably. As a result, the water treatment efficiency is further enhanced.

Preferably, a time period from start of supply to stop of supply of the air bubble by the air bubble supplying portion is 3 seconds or longer and 20 seconds or shorter. Since the aforementioned time period from start of supply to stop of supply of the air bubble is set to be within the aforementioned range as described above, it is possible to prevent the oil droplet, the suspended substance particle and the like separated from the particles from adhering to the other treatment layers and to discharge these from the discharge portion, and thus, the particles can be cleaned more easily and reliably. As a result, the water treatment efficiency is further enhanced.

Supply of the backwash water by the backwash water supplying portion may be started substantially at the same time as stop of supply of the air bubble by the air bubble supplying portion. Since supply of the backwash water by the backwash water supplying portion is started substantially at the same time as stop of supply of the air bubble as described above, the oil droplet, the suspended substance particle and the like separated from the particles can be discharged from the discharge portion before adhering to the other treatment layers. Therefore, for example, by combining a piping for supplying the air bubble and a piping for supplying the backwash water to form one piping and switching the piping by a switching valve and the like, supply of the backwash water can be started immediately after the air bubble is supplied. As a result, the cost of the facilities can be reduced. It is noted that “the backwash water is supplied substantially at the same time as stop of supply of the air bubble” means that the backwash water is supplied within one second after supply of the air bubble is stopped.

Preferably, an average diameter of the air bubble is 3 mm or larger and 8 mm or smaller. Since the average diameter of the air bubble is set to be within the aforementioned range as described above, the particles are cliffused appropriately, which makes it easier to separate the oil droplet, the suspended substance particle and the like having adhered to the particles. As a result, the water treatment efficiency is further enhanced. It is noted that “average diameter of the air bubble” is obtained by taking a microscopic enlarged picture of the air bubbles in the liquid to be treated, randomly selecting 10 air bubbles from the taken microscopic enlarged picture, and determining an average of diameters of these 10 air bubbles. If the selected air bubble is not a true circle, an average of a longer diameter and a shorter diameter of the air bubble is defined as the diameter of the air bubble.

Preferably, a filling rate of the particles between the upper partition plate and a lower partition plate is 10 vol % or higher and 95 vol % or lower. Since the aforementioned filling rate is set to be within the aforementioned range as described above, the particles are sufficiently diffused into the liquid to be treated, which makes it easier to separate the oil droplet, the suspended substance particle and the like having adhered to the particles. As a result, the water treatment efficiency is further enhanced. It is noted that “filling rate of the particles in the space between the upper partition plate and the lower partition plate” refers to a volume ratio of the particle layer in the steady state to an inner volume of the space between the upper partition plate and the lower partition plate.

An average diameter of the particles contained in a downstream-side treatment layer may be smaller than an average diameter of the particles contained in an upstream-side treatment layer. Since the average diameter of the particles contained in the downstream-side treatment layer is set to be smaller than the average diameter of the particles contained in the upstream-side treatment layer as described above, the oil droplet, the suspended substance particle and the like having a relatively large particle diameter can be separated in the upstream-side treatment layer, and thereafter, the emulsified oil droplet, the minute suspended substance particle and the like can be separated in the downstream-side treatment layer. As a result, the water treatment efficiency is further enhanced.

A first treatment layer and a second treatment layer may be provided in order from the upstream side, and first particles contained in the first treatment layer may be mainly composed of a high-molecular compound, and second particles contained in the second treatment layer may be mainly composed of diatomite. Since the first particles are mainly composed of a high-molecular compound and the second particles are mainly composed of diatomite as described above, the oil droplet, the suspended substance particle and the like having a relatively large particle diameter can be further separated in the upstream-side treatment layer, and thereafter, the emulsified oil droplet, the minute suspended substance particle and the like can be further separated in the downstream-side treatment layer. As a result, the water treatment efficiency is further enhanced.

An intermediate treatment layer may be further provided between the first treatment layer and the second treatment layer, and intermediate particles contained in the intermediate treatment layer may be mainly composed of a high-molecular compound. Since the intermediate treatment layer is provided as described above, the oil droplet having a relatively large particle diameter, the emulsified oil droplet, the minute suspended substance particle and the like can be purified more easily and reliably.

Therefore, the water treatment apparatus can be suitably used as an apparatus that obtains, from the liquid to be treated including the oil and the suspended substance, the treated water from which the oil and the suspended substance are separated.

Another present invention is directed to a water treatment method having a step of supplying a liquid to be treated to the water treatment apparatus, and recovering a treated liquid.

In the water treatment method, the liquid to be treated is treated by using the water treatment apparatus, and thus, the particles can be efficiently cleaned.

### Details of Embodiment of the Present Invention

An embodiment of the water treatment apparatus and the water treatment method according to the present invention will be detailed below.

### Water Treatment Apparatus

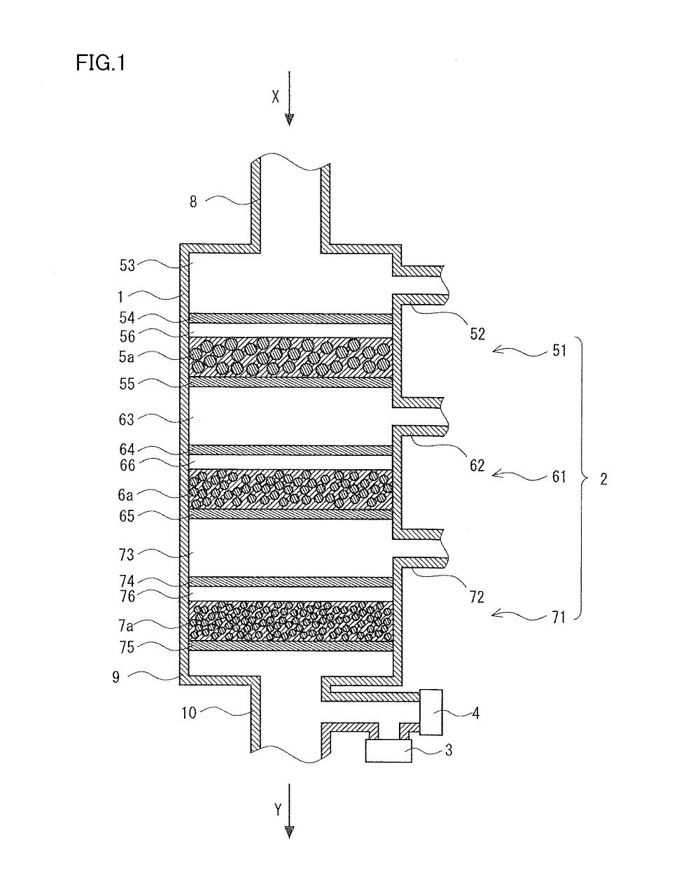

A water treatment apparatus of FIG. 1 includes a cylindrical main body 1 disposed in a substantially perpendicular direction, a treatment portion 2 for purifying a liquid to be treated, an air bubble supplying portion 3 for supplying an air bubble into the main body from below, and a backwash water supplying portion 4 for supplying backwash water into the main body from below.

<Main Body>

Main body 1 described above is a cylindrical body and is arranged such that a central axis thereof matches substantially with the perpendicular direction. Main body 1 also has: a liquid-to-be-treated supply pipe 8 connected to a top surface portion, for supplying a liquid to be treated X; a header portion 9 disposed at a lower part of main body 1; and a recovery pipe 10 connected to header portion 9, for recovering a treated liquid Y. Opening/closing means (not shown) such as a valve is disposed at liquid-to-be-treated supply pipe 8 in order to prevent an inflow of the air bubble and the backwash water to the liquid-to-be-treated supply pipe 8 side during bubbling for supplying the air bubble from air bubble supplying portion 3 and during backwashing for supplying the backwash water from backwash water supplying portion 4.

Air bubble supplying portion 3 and backwash water supplying portion 4 are connected to recovery pipe 10 described above, and the air bubble and the backwash water are supplied into main body 1 through recovery pipe 10 during cleaning of a first particle 5a, an intermediate particle 6a and a second particle 7a described below (the first particle, the intermediate particle and the second particle are sometimes referred to collectively as “particle”).

A material of main body 1 is not particularly limited, and metal, synthetic resin and the like can be used. Particularly, from the perspective of strength, heat resistance, chemical resistance and the like, stainless or acrylonitrile-butadiene-styrene copolymer (ABS resin) is preferable. Transparent ABS resin may also be used so as to allow observation of a diffusion state of the oil droplet, the suspended substance particle and the like in main body 1.

A planar shape (bottom surface shape) of main body 1 is not particularly limited, and the planar shape of main body 1 can be circular, rectangular and the like. However, a circular shape is preferable. When the planar shape of main body 1 is configured to be circular, any corners in main body 1 can be eliminated, and it is possible to prevent the corner from being clogged with the particle and the like. There is also a merit of facilitating strength design of main body 1.

A size of main body 1 can be appropriately designed in accordance with an amount of treatment of the liquid to be treated. A diameter of main body 1 can be set at, for example, 0.1 m or larger and 5 m or smaller. A height of main body 1 can be set at, for example, 0.5 in or higher and 10 m or lower.

<Treatment Portion>

In order from the upstream side, as treatment layers that contain particles, treatment portion 2 described above has a first treatment layer 51 that contains a plurality of first particles 5a, an intermediate treatment layer 61 that contains a plurality of intermediate particles 6a having an average diameter smaller than that of these first particles 5a, and a second treatment layer 71 that contains a plurality of second particles 7a having an average diameter smaller than that of these intermediate particles 6a. It is noted that these first treatment layer, intermediate treatment layer and second treatment layer are sometimes referred to collectively as “treatment layer”. In addition, treatment portion 2 further has a first discharge portion 52 disposed above first treatment layer 51, an intermediate discharge portion 62 disposed above intermediate treatment layer 61, and a second discharge portion 72 disposed above second treatment layer 71. Each of these first discharge portion 52, intermediate discharge portion 62 and second discharge portion 72 discharges at least one of the air bubble and the backwash water. It is noted that these first discharge portion, the intermediate discharge portion and the second discharge portion are sometimes referred to collectively as “discharge portion”.

<First Treatment Layer>

Among the treatment layers, first treatment layer 51 described above is disposed on the most upstream side in main body 1, and contains the plurality of first particles 5a. First treatment layer 51 has a first upper partition plate 54 for preventing an outflow of contained first particles 5a to the upstream side, and a first lower partition plate 55 for preventing an outflow of contained first particles 5a to the downstream side. First treatment layer 51 also has a first space portion 56 formed in a space between first upper partition plate 54 and first particles 5a deposited on the upper surface side of first lower partition plate 55 in the steady state. This first treatment layer 51 mainly removes foreign substances such as the oil droplet and the suspended substance particle having a relatively large particle diameter which are included in the liquid to be treated.

(First Particle)

A known particle for filtration treatment can be used as first particle 5a described above, and a particle mainly composed of sand, a high-molecular compound, a natural material or the like having a relatively large particle diameter can, for example, be used. Examples of the aforementioned sand can include, for example, anthracite, garnet, manganese sand and the like, and these can be used alone or two or more of these can be used in combination.

Examples of the aforementioned high-molecular compound can include, for example, ethylene-vinyl acetate copolymer resin, vinyl resin, polyolefin resin, polyurethane resin, epoxy resin, polyester resin, polyamide resin, polyimide resin, melamine resin, polycarbonate resin and the like. Among these, ethylene-vinyl acetate copolymer resin which is excellent in flexibility is preferable, and vinyl resin, polyurethane resin, epoxy resin, and acrylic resin which are excellent in water resistance, oil resistance and the like are preferable, and polyolefin resin which is excellent in adsorptivity is more preferable. Furthermore, among polyolefin resin, polypropylene resin which is excellent in oil adsorption capability is particularly preferable. In addition, in the case of the high-molecular compound, it is preferable to use an amorphous pulverized particle. When the amorphous pulverized particle is used, the particles can be deposited in a compact manner, and thus, the filtration efficiency can be enhanced and uplift of the particle in the steady state can be prevented.

A material having a particle size adjusted by sieving can be used as the aforementioned natural material, and examples of the aforementioned natural material can include, for example, a walnut shell, sawdust, a natural fiber such as hemp, and the like.

A particle mainly composed of the aforementioned high-molecular compound may be used as first particle 5a. When the particle mainly composed of the high-molecular compound is used as first particle 5a as described above, the cost and weight of the water treatment apparatus can be reduced. In addition, a specific gravity of first particle 5a can be reduced, and thus, the stirring effect during bubbling and during backwashing can be enhanced. It is preferable that this high-molecular compound as first particle 5a has elasticity and is easy to bend. It is expected that this makes it easier to separate the oil droplet, the suspended substance particle and the like having adsorbed to a surface of the particle from the surface.

A lower limit of a tensile elastic modulus of this high-molecular compound is preferably 5 MPa, and more preferably 10 MPa. An upper limit of the tensile elastic modulus is preferably 200 MPa, and more preferably 150 MPa. If this tensile elastic modulus is lower than the aforementioned lower limit, the high-molecular compound may become difficult to deform, and the oil droplet, the suspended substance particle and the like having adsorbed to the surface of the high-molecular compound may become difficult to be separated from the surface. On the other hand, even if this tensile elastic modulus exceeds the aforementioned upper limit, there is a possibility that the capability of separating the oil droplet, the suspended substance particle and the like is not enhanced any further. It is noted that a value measured in conformity with JIS-K7162 (1994) is used as the tensile elastic modulus.

A lower limit of a bending elastic modulus of this high-molecular compound is preferably 5 MPa, and more preferably 10 MPa. An upper limit of the bending elastic modulus is preferably 200 MPa, and more preferably 150 MPa. If this bending elastic modulus is lower than the aforementioned lower limit, the high-molecular compound may become difficult to deform, and the oil droplet, the suspended substance particle and the like having adsorbed to the surface of the high-molecular compound may become difficult to be separated from the surface. On the other hand, even if this bending elastic modulus exceeds the aforementioned upper limit, there is a possibility that the capability of separating the oil droplet, the suspended substance particle and the like is not enhanced any further. It is noted that a value measured in conformity with JIS-K7171 (2008) is used as the bending elastic modulus.

An upper limit of a durometer hardness (type A) of this high-molecular compound is preferably 110, and more preferably 98. A lower limit of this durometer hardness is preferably 60, and more preferably 70. If this durometer hardness exceeds the aforementioned upper limit, the high-molecular compound may become difficult to deform, and the oil droplet, the suspended substance particle and the like having adsorbed to the surface of the high-molecular compound may become difficult to be separated from the surface. On the other hand, even if this durometer hardness is lower than the aforementioned lower limit, there is a possibility that the capability of separating the oil droplet, the suspended substance particle and the like is not enhanced any further. It is noted that a value measured in conformity with JIS-K7215 (1986) is used as the durometer hardness (type A).

A lower limit of the average diameter of first particles 5a is preferably 400 μm, and more preferably 450 μm. If the average diameter of first particles 5a is smaller than the aforementioned lower limit, a density of the particles contained in first treatment layer 51 may become high and a pressure loss of the water treatment apparatus may become large, and the cost and weight of the water treatment apparatus may increase. On the other hand, an upper limit of the average diameter of first particles 5a is preferably 1000 μm, more preferably 800 μm, and further preferably 600 μm. If the average diameter of first particles 5a exceeds the aforementioned upper limit, the capability of removing the oil droplet, the suspended substance particle and the like having a relatively large particle diameter may become insufficient. It is noted that used as the average diameter of the particles is a value obtained by using sieves defined in accordance with JIS-Z8801-1 (2006) to sieve the particles in descending order of mesh size and perform calculation based on the number of particles on the sieve and the mesh size of each sieve.

A lower limit of a uniformity coefficient of first particles 5a is preferably 1.1, and more preferably 1.3. If the uniformity coefficient of first particles 5a is lower than the aforementioned lower limit, variations in particles may become small and there is a possibility that the particles cannot be deposited in a compact manner. On the other hand, an upper limit of the uniformity coefficient of first particles 5a is preferably 1.8, and more preferably 1.6. If the uniformity coefficient of first particles 5a exceeds the aforementioned upper limit, the capability of separating the oil droplet, the suspended substance particle and the like may become non-uniform in first treatment layer 51. It is noted that used as the uniformity coefficient is a value obtained by D60/D10 when D60 represents a mesh size (particle diameter) of a sieve through which 60 mass % of the particles pass and D10 represents a mesh size (particle diameter) of a sieve through which 10 mass % of the particles pass.

A lower limit of a porosity of first treatment layer 51 is preferably 30 vol %, and more preferably 40 vol %. If the porosity of first treatment layer 51 is lower than the aforementioned lower limit, there is a possibility that the particles cannot be stirred sufficiently by the air bubble. On the other hand, an upper limit of the porosity of first treatment layer 51 is preferably 95 vol %, and more preferably 90 vol %. Even if the porosity of first treatment layer 51 exceeds the aforementioned upper limit, there is a possibility that the effect of stirring the particles by the air bubble is not enhanced any further. It is noted that the porosity refers to a volume ratio of a space having no particles to the layer having the particles deposited thereon in the steady state.

(First Space Portion)

First space portion 56 is a space between first upper partition plate 54 and first particles 5a deposited on the upper surface side of first lower partition plate 55 in the steady state. A part of the oil and the suspended substance particle separated in first treatment layer 51 stay (are lifted up and separated) in this first space portion 56 and are discharged from first discharge portion 52 together with the backwash water during backwashing. In addition, during backwashing, first particles 5a rise into this first space portion 56 and are stirred, and thereby, first treatment layer 51 can be effectively backwashed. This first space portion as well as an intermediate space portion and a second space portion described below are sometimes referred to collectively as “space portion”.

A lower limit of a filling rate of first particles 5a in the space between first upper partition plate 54 and first lower partition plate 55 is preferably 10 vol %, more preferably 20 vol %, and further preferably 40 vol %. An upper limit of the filling rate of first particles 5a in the space between first upper partition plate 54 and first lower partition plate 55 is preferably 95 vol %, more preferably 80 vol %, and further preferably 70 vol %. If the aforementioned filling rate exceeds the aforementioned upper limit, a space for diffusion of first particles 5a is small, and thus, there is a possibility that the effect of stirring first particles 5a during backwashing is not obtained sufficiently. On the other hand, even if the aforementioned filling rate is lower than the aforementioned lower limit, there is a sufficient space for diffusion of first particles 5a, and thus, there is a possibility that the effect of stirring first particles 5a during backwashing is not enhanced any further. It is noted that an average thickness of a deposition layer of first particles 5a in the steady state can be set at, for example, 1 cm or larger and 1 m or smaller.

(First Upper Partition Plate)

First upper partition plate 54 described above is a plate for preventing an outflow of first particles 5a to the upstream side. Namely, first upper partition plate 54 has a configuration that does not allow first particles 5a to pass therethrough and allows the liquid to pass therethrough. Specifically, first upper partition plate 54 has a mesh (net) structure. This first upper partition plate 54 as well as an intermediate upper partition plate 64 and a second upper partition plate 74 described below are sometimes referred to collectively as “upper partition plate”.

A material of first upper partition plate 54 is not particularly limited, and metal, synthetic resin and the like can be used. When metal is used, it is preferable to use stainless (particularly, SUS316L) from the perspective of anticorrosion. When synthetic resin is used, it is preferable to use a support member such as a reinforced wire together such that the mesh size does not vary with the water pressure and the weight of the particles.

A nominal mesh size of the mesh of first upper partition plate 54 is designed to be equal to or smaller than a minimum diameter of the plurality of first particles 5a (maximum mesh size of the sieve through which first particles 5a do not pass). An upper limit of this nominal mesh size of the mesh of first upper partition plate 54 is preferably 400 μm, and more preferably 350 μm. If the aforementioned nominal mesh size exceeds the aforementioned upper limit, first particles 5a may pass through first upper partition plate 54. On the other hand, a lower limit of the aforementioned nominal mesh size is preferably 10 μm, and more preferably 40 μm. If the aforementioned nominal mesh size is smaller than the aforementioned lower limit, the pressure loss of the water treatment apparatus may become large.

(First Lower Partition Plate)

First lower partition plate 55 described above is a plate for preventing falling of first particles 5a. Namely, first lower partition plate 55 has a configuration that does not allow first particles 5a to pass therethrough and allows the liquid to pass therethrough. Specifically, first lower partition plate 55 has a mesh (net) structure. This first lower partition plate 55 as well as an intermediate lower partition plate 65 and a second lower partition plate 75 described below are sometimes referred to collectively as “lower partition plate”.

Similarly to first upper partition plate 54, a material of first lower partition plate 55 is not particularly limited, and metal, synthetic resin and the like can be used. When metal is used, it is preferable to use stainless (particularly, SUS316L) from the perspective of anticorrosion. When synthetic resin is used, it is preferable to use a support member such as a reinforced wire together such that the mesh size does not vary with the water pressure and the weight of the particles.

Similarly to first upper partition plate 54, a nominal mesh size of the mesh of first lower partition plate 55 is designed to be equal to or smaller than a minimum diameter of the plurality of first particles 5a (maximum mesh size of the sieve through which first particles 5a do not pass). An upper limit of this nominal mesh size of the mesh of first lower partition plate 55 is preferably 100 μm. If the aforementioned nominal mesh size exceeds the aforementioned upper limit, first particles 5a or intermediate particles 6a may pass through first lower partition plate 55. On the other hand, a lower limit of the aforementioned nominal mesh size is preferably 10 μm, and more preferably 40 μm. If the aforementioned nominal mesh size is smaller than the aforementioned lower limit, the pressure loss of the water treatment apparatus may become large.

(First Retention Portion)

The water treatment apparatus has a first retention portion 53 which is a space provided between the top surface of main body 1 and first upper partition plate 54. First discharge portion 52 is connected to this first retention portion 53. A part of the oil droplet, the suspended substance particle and the like separated in first treatment layer 51 stay (are lifted up and separated) in this first retention portion 53 and are discharged from first discharge portion 52 together with the backwash water during backwashing. This first retention portion 53 as well as an intermediate retention portion 63 and a second retention portion 73 described below are sometimes referred to collectively as “retention portion”.

A lower limit of an average height of first retention portion 53 (distance between the top surface of main body 1 and first upper partition plate 54) is preferably 1 cm, and more preferably 2 cm. An upper limit of the average height of first retention portion 53 is preferably 3 m, and more preferably 50 cm. If the average height of first retention portion 53 is lower than the aforementioned lower limit, the oil droplet, the suspended substance particle and the like separated during bubbling may adsorb to the top surface of main body 1 and become difficult to be discharged from first discharge portion 52. On the other hand, if the average height of first retention portion 53 exceeds the aforementioned upper limit, main body 1 may become too high.

(First Discharge Portion)

First discharge portion 52 is provided directly above first treatment layer 51, and discharges the oil droplet, the suspended substance particle and the like separated in first treatment layer 51, together with the backwash water.

An upper limit of a distance from an upper surface of first upper partition plate 54 to a lower end of first discharge portion 52 is preferably 50 cm, more preferably 10 cm, and further preferably 0 cm. If the distance from the upper surface of first upper partition plate 54 to the lower end of first discharge portion 52 exceeds the aforementioned upper limit, the oil droplet, the suspended substance particle and the like separated during bubbling may adsorb to the other treatment layers before being discharged from first discharge portion 52, and become difficult to be discharged. Opening/closing means (not shown) such as a valve is provided at first discharge portion 52 in order to prevent an inflow of the liquid to be treated to the first discharge portion 52 side in the steady state.

<Intermediate Treatment Layer>

Intermediate treatment layer 6l described above is disposed on the downstream side of first treatment layer 51 and contains the plurality of intermediate particles 6a. Intermediate treatment layer 61 has intermediate upper partition plate 64 for preventing an outflow of contained intermediate particles 6a to the upstream side, and intermediate lower partition plate 65 for preventing an outflow of contained intermediate particles 6a to the downstream side. Intermediate treatment layer 61 also has an intermediate space portion 66 formed in a space between intermediate upper partition plate 64 and intermediate particles 6a deposited on the upper surface side of intermediate lower partition plate 65 in the steady state. This intermediate treatment layer 61 mainly removes the oil droplet, the suspended substance particle and the like having a diameter smaller than that of the oil droplet, the suspended substance particle and the like filtered in first treatment layer 51.

(Intermediate Particle)

A material of intermediate particles 6a described above can be similar to that of first particles 5a described above.

An average diameter of intermediate particles 6a is smaller than the average diameter of first particles 5a described above. A lower limit of the average diameter of intermediate particles 6a is preferably 150 μm, and more preferably 200 μm. If the average diameter of intermediate particles 6a is smaller than the aforementioned lower limit, a density of the particles contained in intermediate treatment layer 61 may become high and the pressure loss of the water treatment apparatus may become large, and the cost and weight of the water treatment apparatus may increase. On the other hand, an upper limit of the average diameter of intermediate particles 6a is preferably 350 μm, and more preferably 300 μm. If the average diameter of intermediate particles 6a exceeds the aforementioned upper limit, the capability of removing the oil droplet, the suspended substance particle and the like may become insufficient. A uniformity coefficient of intermediate particles 6a can be similar to that of first particles 5a described above.

(Intermediate Space Portion)

Intermediate space portion 66 is a space between intermediate upper partition plate 64 and intermediate particles 6a deposited on the upper surface side of intermediate lower partition plate 65 in the steady state. The configuration of this intermediate space portion 66 can be similar to that of first space portion 56 described above.

(Intermediate Upper Partition Plate)

Intermediate upper partition plate 64 described above is a plate for preventing an outflow of intermediate particles 6a to the upstream side. Except for the nominal mesh size of the mesh, the configuration of intermediate upper partition plate 64 described above can be similar to that of first upper partition plate 54 described above.

A nominal mesh size of the mesh of intermediate upper partition plate 64 is designed to be equal to or smaller than a minimum diameter of the plurality of intermediate particles 6a (maximum mesh size of the sieve through which intermediate particles 6a do not pass). An upper limit of this nominal mesh size of the mesh of intermediate upper partition plate 64 is preferably 150 μm, and more preferably 100 μm. If the aforementioned nominal mesh size exceeds the aforementioned upper limit, intermediate particles 6a may pass through intermediate upper partition plate 64. On the other hand, a lower limit of the aforementioned nominal mesh size is preferably 10 μm, and more preferably 20 μm. If the aforementioned nominal mesh size is smaller than the aforementioned lower limit, the pressure loss of the water treatment apparatus may become large.

(Intermediate Lower Partition Plate)

Intermediate lower partition plate 65 described above is a plate for preventing falling of intermediate particles 6a. Except for the nominal mesh size of the mesh, the configuration of intermediate lower partition plate 65 described above can be similar to that of first lower partition plate 55 described above.

Similarly to intermediate upper partition plate 64, a nominal mesh size of the mesh of intermediate lower partition plate 65 is designed to be equal to or smaller than a minimum diameter of the plurality of intermediate particles 6a (maximum mesh size of the sieve through which intermediate particles 6a do not pass). An upper limit of this nominal mesh size of the mesh of intermediate lower partition plate 65 is preferably 100 μm, and more preferably 80 μm or smaller. If the aforementioned nominal mesh size exceeds the aforementioned upper limit, intermediate particles 6a or second particles 7a may pass through intermediate lower partition plate 65. On the other hand, a lower limit of the aforementioned nominal mesh size is preferably 10 μm, and more preferably 20 μm. If the aforementioned nominal mesh size is smaller than the aforementioned lower limit, the pressure loss of the water treatment apparatus may become large.

(Intermediate Retention Portion)

The water treatment apparatus has intermediate retention portion 63 which is a space provided between first lower partition plate 55 and intermediate upper partition plate 64. Intermediate discharge portion 62 is connected to this intermediate retention portion 63. A part of the oil droplet, the suspended substance particle and the like separated in intermediate treatment layer 61 stay (are lifted up and separated) in this intermediate retention portion 63 and are discharged from intermediate discharge portion 62 together with the backwash water during backwashing. The configuration of intermediate retention portion 63 can be similar to that of first retention portion 53 described above.

(Intermediate Discharge Portion)

Intermediate discharge portion 62 is provided directly above intermediate treatment layer 61, and discharges the oil droplet, the suspended substance particle and the like separated in intermediate treatment layer 61, together with the backwash water. The configuration of intermediate discharge portion 62 can be similar to that of first discharge portion 52 described above.

<Second Treatment Layer>

Second treatment layer 71 described above is disposed on the downstream side of intermediate treatment layer 61 and contains the plurality of second particles 7a. Second treatment layer 71 has second upper partition plate 74 for preventing an outflow of contained second particles 7a to the upstream side, and second lower partition plate 75 for preventing an outflow of contained second particles 7a to the downstream side. Second treatment layer 71 also has a second space portion 76 formed in a space between second upper partition plate 74 and second particles 7a deposited on the upper surface side of second lower partition plate 75 in the steady state. This second treatment layer 71 mainly removes the minute oil droplet, suspended substance particle and the like included in the liquid to be treated.

(Second Particle)

A known particle for filtration treatment can be used as second particle 7a described above, and a particle mainly composed of a natural material, a high-molecular compound or the like having a relatively small particle diameter can, for example, be used. Examples of the aforementioned natural material can include, for example, diatomite and the like. The configuration of the aforementioned high-molecular compound can be similar to that of the high-molecular compound in first particle 5a described above.

It is preferable to use the aforementioned diatomite as second particle 7a. When diatomite is used, the oil content in the liquid to be treated can be efficiently removed.

An average diameter of second particles 7a is smaller than the average diameter of intermediate particles 6a described above. A lower limit of the average diameter of second particles 7a is preferably 10 μm, and more preferably 20 μm. If the average diameter of second particles 7a is smaller than the aforementioned lower limit, a density of the particles contained in second treatment layer 71 may become high and the pressure loss of the water treatment apparatus may become large, and the cost and weight may increase. On the other hand, an upper limit of the average diameter of second particles 7a is preferably 100 μm, and more preferably 90 μm. If the average diameter of second particles 7a exceeds the aforementioned upper limit, the capability of removing the minute oil droplet and suspended substance may become insufficient. A uniformity coefficient of second particles 7a can be similar to that of first particles 5a described above.

(Second Space Portion)

Second space portion 76 is a space between second upper partition plate 74 and second particles 7a deposited on the upper surface side of second lower partition plate 75 in the steady state. The configuration of this second space portion 76 can be similar to that of first space portion 56 described above.

(Second Upper Partition Plate)

Second upper partition plate 74 described above is a plate for preventing an outflow of second particles 7a to the upstream side. Except for the nominal mesh size of the mesh, the configuration of second upper partition plate 74 can be similar to that of first upper partition plate 54 described above.

A nominal mesh size of the mesh of second upper partition plate 74 is designed to be equal to or smaller than a minimum diameter of the plurality of second particles 7a (maximum mesh size of the sieve through which second particles 7a do not pass). An upper limit of this nominal mesh size of the mesh of second upper partition plate 74 is preferably 100 μm, and more preferably 40 μm. If the aforementioned nominal mesh size exceeds the aforementioned upper limit, second particles 7a may pass through second upper partition plate 74. On the other hand, a lower limit of the aforementioned nominal mesh size is preferably 10 μm, and more preferably 20 μm. If the aforementioned nominal mesh size is smaller than the aforementioned lower limit, the pressure loss of the water treatment apparatus may become large.

(Second Lower Partition Plate)

Second lower partition plate 75 described above is a plate for preventing falling of second particles 7a. Except for the nominal mesh size of the mesh, the configuration of second lower partition plate 75 can be similar to that of first lower partition plate 55 described above.

Similarly to second upper partition plate 74, a nominal mesh size of the mesh of second lower partition plate 75 is designed to be equal to or smaller than a minimum diameter of the plurality of second particles 7a (maximum mesh size of the sieve through which second particles 7a do not pass). An upper limit of this nominal mesh size of the mesh of second lower partition plate 75 is preferably 50 μm, and more preferably 40 μm or smaller. If the aforementioned nominal mesh size exceeds the aforementioned upper limit, second particles 7a may pass through second lower partition plate 75. On the other hand, a lower limit of the aforementioned nominal mesh size is preferably 10 μm, and more preferably 20 μm. If the aforementioned nominal mesh size is smaller than the aforementioned lower limit, the pressure loss of the water treatment apparatus may become large.

(Second Retention Portion)

The water treatment apparatus has second retention portion 73 which is a space provided between intermediate lower partition plate 65 and second upper partition plate 74. Second discharge portion 72 is connected to this second retention portion 73. A part of the oil droplet, the suspended substance particle and the like separated in second treatment layer 71 stay (are lifted up and separated) in this second retention portion 73 and are discharged from second discharge portion 72 together with the backwash water during backwashing. The configuration of second retention portion 73 can be similar to that of first retention portion 53 described above.

(Second Discharge Portion)

Second discharge portion 72 is provided directly above second treatment layer 71, and discharges the oil droplet, the suspended substance particle and the like separated in second treatment layer 71, together with the backwash water. The configuration of second discharge portion 72 can be similar to that of first discharge portion 52 described above.

<Header Portion>

Header portion 9 described above is a space formed below second treatment layer 71 described above, i.e., formed between second lower partition plate 75 and a bottom surface of main body 1. Recovery pipe 10 for recovering treated liquid Y is connected to a lower part of this header portion 9, and treated liquid Y having passed through first treatment layer 51, intermediate treatment layer 61 and second treatment layer 71 is collected in this header portion 9 and then is recovered.

<Air Bubble Supplying Portion>

Air bubble supplying portion 3 described above supplies the air bubble from the lower part to the upper part of the water treatment apparatus through recovery pipe 10 described above. Air bubble supplying portion 3 supplies the air bubble by emitting a gas supplied from a compressor and the like through an air supply pipe (not shown). Such air bubble supplying portion 3 is not particularly limited and a known bubbling device can be used. As the gas used in air bubble supplying portion 3, an inert gas such as argon and nitrogen, a natural gas generated in an oilfield, air and the like can be used. When the air is used among these, the cost can be reduced. Due to an upward flow of the air bubble, the plurality of first particles 5a, intermediate particles 6a and second particles 7a are diffused into the liquid, and thereby, the oil droplet, the suspended substance particle and the like having adhered to the particles are separated.

A lower limit of an average diameter of the air bubble is preferably 3 mm, and more preferably 4 mm. An upper limit of the average diameter of the air bubble is preferably 8 mm, and more preferably 7 mm. If the average diameter of the air bubble is smaller than the aforementioned lower limit, diffusion of the particles becomes small, and thus, the oil droplet, the suspended substance and the like having adhered to the particles may become difficult to be separated. On the other hand, if the average diameter of the air bubble exceeds the aforementioned upper limit, the air bubble is too large and the number of stirring of the particles decreases, and thus, the oil droplet, the suspended substance and the like having adhered to the particles may become difficult to be separated.

A lower limit of a time period from start of supply to stop of supply of the air bubble by air bubble supplying portion 3 is preferably 3 seconds, and more preferably 5 seconds. An upper limit of the time period from start of supply to stop of supply of the air bubble is preferably 20 seconds, and more preferably 10 seconds. If the time period from start of supply to stop of supply of the air bubble is shorter than the aforementioned lower limit, diffusion of the particles by the air bubble becomes small, and thus, there is a possibility that the oil droplet, the suspended substance particle and the like having adhered to the particles are not separated. On the other hand, if the time period from start of supply to stop of supply of the air bubble exceeds the aforementioned upper limit, the separated oil droplet, suspended substance particle and the like may adhere to the other treatment layers and become difficult to be discharged from the discharge portion.

<Backwash Water Supplying Portion>

Backwash water supplying portion 4 described above supplies the backwash water from the lower part to the upper part of the water treatment apparatus through recovery pipe 10 described above. A tip end of a pipe of this backwash water supplying portion 4 for supplying the backwash water and a pipe of aforementioned air bubble supplying portion 3 for supplying the air bubble form one common piping, and at least one of the backwash water and the air bubble is supplied by using a switching valve (not shown). Backwash water supplying portion 4 supplies the backwash water by, for example, pressure-feeding the treated liquid by a pump. By this backwash water, the oil droplet, the suspended substance particle and the like separated from the particles by the aforementioned air bubble are discharged from the discharge portion together with the backwash water, and are recovered in a backwash water recovery portion described below.

A lower limit of a time period from start of supply to stop of supply of the backwash water by backwash water supplying portion 4 is preferably 5 seconds, and more preferably 10 seconds. An upper limit of the aforementioned time period from start of supply to stop of supply of the backwash water is preferably 100 seconds, and more preferably 60 seconds. If the time period from start of supply to stop of supply of the backwash water is shorter than the aforementioned lower limit, there is a possibility that the oil droplet, the suspended substance particle and the like separated from the particles are not completely discharged from the discharge portion and remain. On the other hand, even if the time period from start of supply to stop of supply of the backwash water exceeds the aforementioned upper limit, the oil droplet, the suspended substance particle and the like separated from the particles have been fully discharged from the discharge portion, and thus, further supply of the backwash water is a waste of time and the efficiency of backwashing may decrease.

<Backwash Water Recovery Portion>

The aforementioned backwash water recovery portion (not shown) recovers the backwash water including the oil droplet, the suspended substance particle and the like through the discharge portion. This recovered backwash water can, for example, be supplied again to the water treatment apparatus as liquid to be treated X.

<Advantage>

The water treatment apparatus has first space portion 56 between first upper partition plate 54 and the particles of the treatment layer, intermediate space portion 66 between intermediate upper partition plate 64 and the particles of the treatment layer, and second space portion 76 between second upper partition plate 74 and the particles of the treatment layer. As a result, when the air bubble is supplied to the particles, the particles are stirred by the air bubble and the particles are easily diffused, which makes it easier to separate the oil droplet, the suspended substance particle and the like having adhered to the particles. 111 addition, since the backwash water is supplied and discharged from the discharge port, the oil droplet, the suspended substance particle and the like separated from the particles are discharged without adhering to the other treatment layers. As a result of these, the particles can be cleaned easily and reliably. Consequently, the water treatment apparatus has a high water treatment efficiency.

In addition, in the water treatment apparatus, supply of the air bubble by air bubble supplying portion 3 and supply of the backwash water by backwash water supplying portion 4 are repeated, and the air bubble and the backwash water are discharged from the discharge portion located directly above the treatment layer. Since supply of the air bubble and supply of the backwash water are repeated as described above, the oil droplet, the suspended substance particle and the like having adhered to the particles are sufficiently separated and discharged. In addition, since the oil droplet, the suspended substance particle and the like are discharged from the discharge portion located directly above the treatment layer, the separated oil droplet, suspended substance particle and the like become difficult to adhere to the other treatment layers.

In addition, in the water treatment apparatus, the air bubble is supplied by air bubble supplying portion 3, and supply of the backwash water by backwash water supplying portion 4 can be started before the oil droplet, the suspended substance particle and the like separated from the particles by the air bubble float in the retention portion and adhere to the other treatment layers. Since supply of the backwash water is started as described above, the oil droplet, the suspended substance particle and the like are discharged immediately, and thus, the particles can be cleaned easily and reliably.

In addition, in the water treatment apparatus, the average diameter of the particles contained in the downstream-side treatment layer is set to be smaller than the average diameter of the particles contained in the upstream-side treatment layer. Therefore, the oil droplet, the suspended substance particle and the like having a relatively large particle diameter can be separated in the upstream-side treatment layer, and thereafter, the emulsified oil droplet, the minute suspended substance particle and the like can be separated in the downstream-side treatment layer. As a result, the water treatment efficiency is further enhanced.

### Water Treatment Method

The water treatment method includes a purification step of supplying the liquid to be treated to the water treatment apparatus and recovering the treated liquid, and a backwashing step of backwashing the treatment layer. The detail of the water treatment method will be described hereinafter by using the water treatment apparatus of FIG. 1.

<Purification Step>

A method for supplying the liquid to be treated in the aforementioned purification step is not particularly limited, and a method for pressure-feeding the liquid to be treated to the water treatment apparatus by using a pump or water head can, for example, be used.

An upper limit of a suspended substance concentration of the treated liquid recovered in accordance with the water treatment method is preferably 10 ppm, more preferably 5 ppm, further preferably 3 ppm, and particularly preferably 1 ppm or lower. When the suspended substance concentration of the treated liquid is set to be equal to or lower than the aforementioned upper limit, the treated liquid treated in accordance with the water treatment method can be discarded without applying any load to the environment and can be used as the industrial water. It is noted that the suspended substance concentration refers to a concentration of a floating substance (SS) and a value measured in conformity with “14.1 Suspended Matter” in JIS-K0102 (2008) is used.

An upper limit of an oil concentration of the treated liquid recovered in accordance with the water treatment method is preferably 100 ppm, more preferably 50 ppm, further preferably 10 ppm, and particularly preferably 1 ppm or lower. When the oil concentration of the treated liquid is set to be equal to or lower than the aforementioned upper limit, the load of the oil-water separation treatment performed after the water treatment method can be reduced. Depending on the conditions, the treated liquid that was oil-water separated in accordance with the water treatment method can be discarded without applying any load to the environment, even if the other oil-water separation treatment is not performed.

When the oil droplet, the suspended substance particle and the like having adhered to the particles increase and a differential pressure between the upper part and the lower part of each treatment layer becomes large in the aforementioned purification step, the purification step is ended and the next backwashing step is performed to clean the particles.

<Backwashing Step>

The backwashing step has a step of supplying the air bubble and a step of supplying the backwash water.

(Air Bubble Supplying Step)

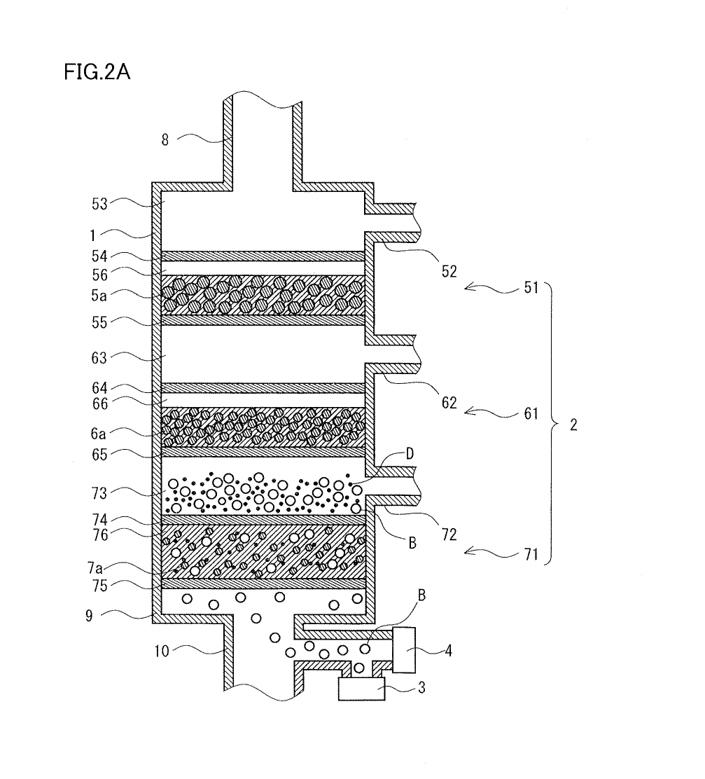

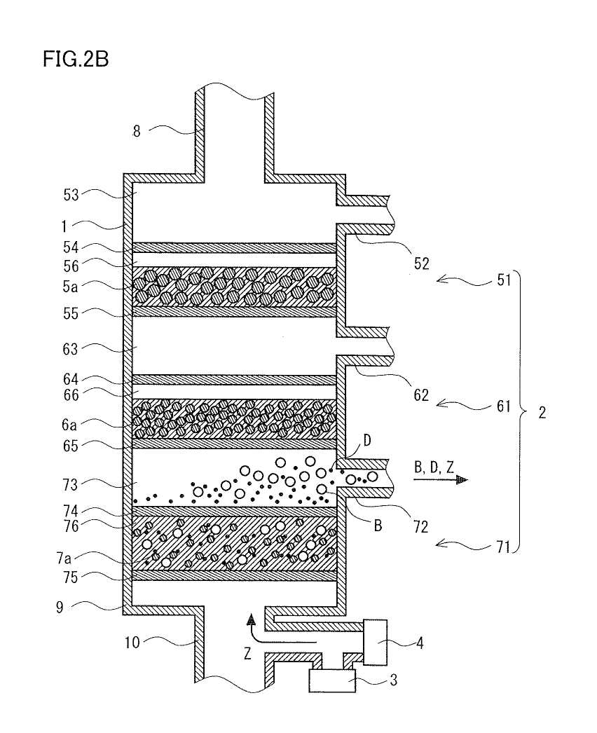

In the air bubble supplying step, air bubble supplying portion 3 supplies an air bubble B having the aforementioned diameter to treatment portion 2 from below through recovery pipe 10 for the aforementioned time period (see FIG. 2A). The particles are stirred and diffused in the liquid by this air bubble B, and an oil droplet, a suspended substance particle and the like D having adhered to the particles are separated.

(Backwash Water Supplying Step)

In the backwash water supplying step, backwash water supplying portion 4 supplies backwash water Z to treatment portion 2 from below through recovery pipe 10 (see FIG. 2B). By this backwash water Z, the oil droplet, the suspended substance particle and the like D separated from the particles are discharged from the discharge portion.

It is preferable to perform this backwash water supplying step substantially at the same time as stop of the aforementioned air bubble supplying step. When supply of backwash water Z by backwash water supplying portion 4 is started substantially at the same time as stop of supply of air bubble B as described above, the oil droplet, the suspended substance particle and the like D separated from the particles are discharged from the discharge portion before adhering to the other treatment layers.

Furthermore, it is preferable to start this backwash water supplying step when the oil droplet, the suspended substance particle and the like separated from the treatment layer in the air bubble supplying step are floating in the retention portion. As a result, the oil droplet, the suspended substance particle and the like D separated from the treatment layer are discharged from the discharge port without adsorbing to the other treatment layers. Such start of the backwash water supplying step is performed as follows, for example. For each condition such as an amount of bubbling, a check is preliminarily made of a time period from the start of bubbling, which elapses from when the oil droplet, the suspended substance particle and the like separated from the treatment layer start to float in the retention portion by bubbling in the air bubble supplying step to when the oil droplet, the suspended substance particle and the like adsorb to the other treatment layers. Then, the backwash water supplying step is started within this time period. As a result, backwash water Z can be supplied when the oil droplet, the suspended substance particle and the like D are floating in the retention portion. Alternatively, the main body may be made of a transparent material to observe the treatment layer during bubbling, and the backwash water supplying step may be started after the oil droplet, the suspended substance particle and the like D separated from the treatment layer start to float in the retention portion and before the oil droplet, the suspended substance particle and the like D adhere to the other treatment layers.

It is preferable to repeat the air bubble supplying step and the backwash water supplying step. A lower limit of the number of repetitions is preferably twice, and more preferably five times. An upper limit of the aforementioned number of repetitions is preferably twenty times, and more preferably fifteen times. If the aforementioned number of repetitions is smaller than the aforementioned lower limit, there is a possibility that the oil droplet, the suspended substance particle and the like having adhered to the particles cannot be sufficiently separated and discharged. On the other hand, if the aforementioned number of repetitions exceeds the aforementioned upper limit, the oil droplet, the suspended substance particle and the like having adhered to the particles have been sufficiently separated and discharged, and thus, supply of air bubble B and supply of backwash water Z may be repeated wastefully.

The air bubble supplying step and the backwash water supplying step are performed separately for each treatment layer. Therefore, when first treatment layer 51 is backwashed, the opening/closing means of first discharge portion 52 is opened and the opening/closing means of liquid-to-be-treated supply pipe 8, intermediate discharge portion 62 and second discharge portion 72 are closed, such that air bubble B and backwash water Z are discharged only from first discharge portion 52. Similarly, when intermediate treatment layer 61 is backwashed, the opening/closing means of intermediate discharge portion 62 is opened and the opening/closing means of liquid-to-be-treated supply pipe 8, first discharge portion 52 and second discharge portion 72 are closed, such that air bubble B and backwash water Z are discharged only from intermediate discharge portion 62. When second treatment layer 71 is backwashed, the opening/closing means of second discharge portion 72 is opened and the opening/closing means of liquid-to-be-treated supply pipe 8, first discharge portion 52 and intermediate discharge portion 62 are closed, such that air bubble B and backwash water Z are discharged only from second discharge portion 72.

In the water treatment method, the purification step can be again performed after the backwashing step. Since the purification step and the backwashing step are repeated as described above, water treatment can be continuously performed in one water treatment apparatus.

(Advantage)

In the water treatment method, the particles can be cleaned easily and reliably, and a high treatment capability can be maintained. Therefore, the water treatment method can be suitably used for, for example, purification of the petroleum associated water and the like including an oil and a suspended substance generated in an oilfield and the like.

### Other Embodiment

It should be understood that the embodiment disclosed herein is illustrative and not limitative in any respect. The scope of the present invention is not limited to the configuration of the aforementioned embodiment, is defined by the terms of the claims, and is intended to include any modifications within the scope and meaning equivalent to the terms of the claims.

In the aforementioned embodiment, the water treatment apparatus includes three treatment layers, i.e., the first treatment layer, the intermediate treatment layer and the second treatment layer. However, the water treatment apparatus may only include a plurality of treatment layers and the number of the treatment layers is not limited to three. For example, treatment portion 2 may include two layers, i.e., the first treatment layer and the second treatment layer, or treatment portion 2 may include two or more intermediate treatment layers and four or more treatment layers.

In addition, the pipe of the air bubble supplying portion for supplying the air bubble and the pipe of the backwash water supplying portion for supplying the backwash water may be provided independently of each other. When the pipe of the air bubble supplying portion and the pipe of the backwash water supplying portion are made independent of each other as described above, the backwash water can be supplied while supplying the air bubble, and thus, easier and more reliable cleaning of the particles is expected.

In addition, the air bubble supplying portion and the backwash water supplying portion may be disposed for each treatment layer. As a result, easier and more reliable cleaning of the particles is expected.

### Example

The present invention will be described in more detail hereinafter with reference to Example. However, the present invention is not limited to this Example.

Water treatment was performed by using the water treatment apparatus having the three treatment layers in FIG. 1. An inner diameter of main body 1 was set at 40 mm. A material, an average particle diameter, a tensile elastic modulus/bending elastic modulus, a durometer hardness, and a density of the particles in each treatment layer are shown in Table 1. Ethylene-vinyl acetate copolymer resin (hereinafter referred to as “EVA”) powder (“Powder Resin 5015M” manufactured by Tokyo Printing Ink Mfg. Co., Ltd.) was used as first particles 5a. EVA powder (“Powder Resin 2030M” manufactured by Tokyo Printing Ink Mfg. Co., Ltd.) was used as intermediate particles 6a. Diatomite (“Radiolite #3000” manufactured by Maruto Co., Ltd.) was used as second particles 7a.

In addition, a layer thickness, a filling rate, an amount of filling, a bulk density, and a porosity of each treatment layer as well as a height of each retention portion are shown in Table 1. The amount of filling refers to a total mass of the particles contained in the treatment layer. The bulk density refers to a total mass of the particles per unit volume of the treatment layer.

TABLE 1

| | | First | Intermediate | Second |
|---|---|---|---|---|
| | | Treatment | Treatment | Treatment |
| | | Portion | Portion | Portion |
| Particle | Material | EVA | EVA | Diatomite |
| | Average Particle | 500 | 250 | 75 |
| | Diameter (μm) | | | |
| | Tensile Elastic | 20 | 100 | — |
| | Modulus (Mpa) | | | |
| | Bending Elastic | 20 | 100 | — |
| | Modulus (Mpa) | | | |
| | Durometer Hardness | 85 | 97 | — |
| | [Type A] | | | |
| | Density (g/cm³) | 0.94 | 0.93 | 2.3 |
| Treatment | Layer Thickness (mm) | 100 | 100 | 30 |
| Layer | Filling Rate (vol %) | 39 | 38 | 16 |
| | Amount of Filling (g) | 47 | 45 | 14 |
| | Bulk Density (g/cm³) | 0.37 | 0.35 | 0.37 |
| | Porosity (vol %) | 61 | 62 | 84 |
| Retention | Height (mm) | 100 | 100 | 100 |
| Portion | | | | |

An oil-water mixture liquid was used as the liquid to be treated. An oil content concentration of this oil-water mixture liquid was 500 ppm and a 2 μm calcium carbonate concentration was 100 ppm.

By using the water treatment apparatus, the aforementioned oil-water mixture liquid was filtered and purified at a treatment flow rate of 375 m³/m²·day and at an amount of treatment of 0.47 m³/day. Then, when a differential pressure between the upper part and the lower part of the treatment layer became large, purification was stopped, and supply of air bubble B and supply of backwash water Z were repeated to clean the particles in the treatment layers.

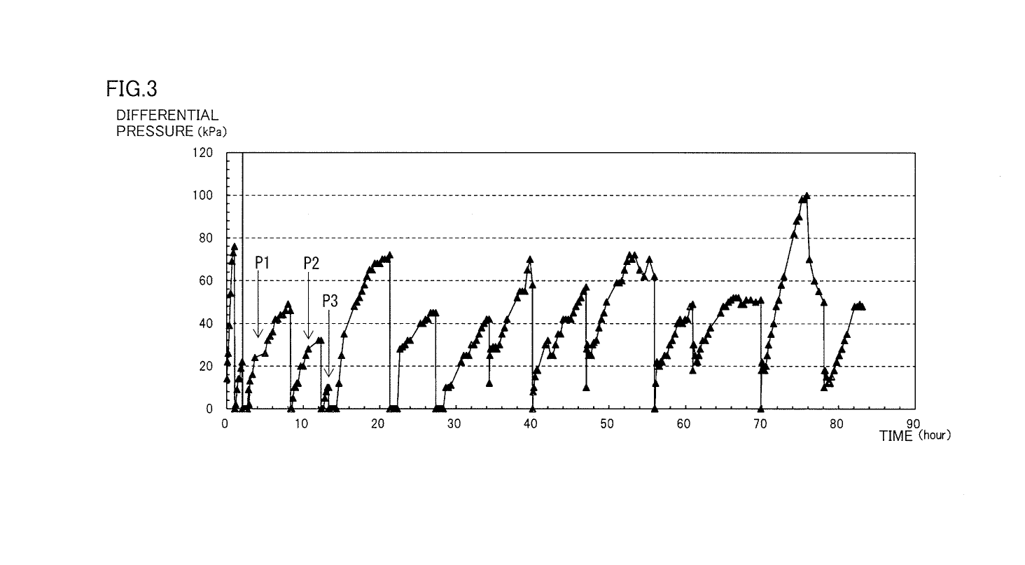

At the time of cleaning of the particles, second particles 7a in second treatment layer 71 were first cleaned, intermediate particles 6a in intermediate treatment layer 61 were next cleaned, and thereafter, first particles 5a in first treatment layer 51 were cleaned. In order to clean the particles, air bubble B having an average diameter of 6 mm was supplied at a rate of 4 L/min for 8 seconds, and supply of backwash water Z was started substantially at the same time as stop of supply of air bubble B, and backwash water Z was supplied at a rate of 0.4 L/min for 22 seconds. Then, supply of air bubble 13 and supply of backwash water Z were continuously repeated five times. At 8 seconds after the start of supply of air bubble B, the oil droplet, the suspended substance particle and the like separated from the particles were floating in each retention portion. However, the oil droplet, the suspended substance particle and the like did not adsorb to an upper surface of each retention portion and an inner surface of a sidewall. FIG. 3 shows transition of a differential pressure between the upper part and the lower part of the second treatment layer during this water treatment.

As described above, purification of the liquid to be treated and cleaning of the particles were repeated for 84 hours. As shown in FIG. 3, the differential pressure increased during purification of the liquid to be treated, and the differential pressure decreased as a result of cleaning of the particles. For each purification during this 84 hours, an amount of increase per hour in differential pressure between the upper part and the lower part of second treatment layer 71 was calculated. Then, an average value (this average value will be hereinafter referred to as “amount of increase per hour in differential pressure during filtration”) of the amounts of increase in the whole purification during this 84 hours was evaluated. Specifically, an amount of increase per hour in differential pressure was calculated for each ascending curve such as ascending curves P1, P2 and P3 of the differential pressure in FIG. 3, and an average of these amounts of increase was defined as the amount of increase per hour in differential pressure during filtration. The smaller this amount of increase per hour in differential pressure during filtration is, the more excellently the oil droplet, the suspended substance particle and the like having adhered to the particles are removed, and the more easily and reliably the particles are cleaned. The amount of increase per hour in differential pressure during filtration in this Example is 7 kPa/h, which shows that the differential pressure between the upper part and the lower part of the treatment layer can be reduced in a short cleaning time.

### INDUSTRIAL APPLICABILITY

The water treatment apparatus and the water treatment method according to the present invention can clean the particles efficiently. As a result, the water treatment apparatus and the water treatment method according to the present invention can be suitably used for, for example, purification of the petroleum associated water.

### REFERENCE SIGNS LIST

1 main body; 2 treatment portion; 3 air bubble supplying portion; 4 backwash water supplying portion; 51 first treatment layer; 52 first discharge portion; 53 first retention portion; 54 first upper partition plate; 55 first lower partition plate; 56 first space portion; 5a first particle; 61 intermediate treatment layer; 62 intermediate discharge portion; 63 intermediate retention portion; 64 intermediate upper partition plate; 65 intermediate lower partition plate; 66 intermediate space portion; 6a intermediate particle; 71 second treatment layer; 72 second discharge portion; 73 second retention portion; 74 second upper partition plate; 75 second lower partition plate; 76 second space portion; 7a second particle; 8 liquid-to-be-treated supply pipe; 9 header portion; 10 recovery pipe.

1. A water treatment apparatus including a cylindrical main body placed in a substantially perpendicular direction, the water treatment apparatus purifying a liquid to be treated supplied from above through the use of a treatment portion filled into at least a part of said main body, and recovering a treated liquid from below, the water treatment apparatus comprising:
a plurality of treatment layers disposed at intervals and in an axial direction in said main body, each of said plurality of treatment layers having particles contained therein and having a pair of partition plates for preventing upward and downward outflow of said particles;
an air bubble supplying portion for supplying an air bubble into said main body from below;
a backwash water supplying portion for supplying backwash water into said main body from below; and
a discharge portion disposed above each treatment layer in said main body, for discharging at least one of said air bubble and said backwash water, wherein
a space portion is provided between an upper partition plate and said particles of said treatment layer in a steady state.

2. The water treatment apparatus according to claim 1, wherein
during cleaning in said treatment layer, supply of said air bubble by said air bubble supplying portion and supply of said backwash water by said backwash water supplying portion are repeated, and said air bubble and said backwash water are discharged from said discharge portion located directly above said treatment layer.

3. The water treatment apparatus according to claim 1, wherein
a time period from start of supply to stop of supply of said air bubble by said air bubble supplying portion is 3 seconds or longer and 20 seconds or shorter.

4. The water treatment apparatus according to claim 1, wherein
supply of said backwash water by said backwash water supplying portion is started substantially at the same time as stop of supply of said air bubble by said air bubble supplying portion.

5. The water treatment apparatus according to claim 1, wherein
an average diameter of said air bubble is 3 mm or larger and 8 mm or smaller.

6. The water treatment apparatus according to claim 1, wherein
a filling rate of said particles between said upper partition plate and a lower partition plate is 10 vol % or higher and 95 vol % or lower.

7. The water treatment apparatus according to claim 1, wherein
an average diameter of the particles contained in a downstream-side treatment layer is smaller than an average diameter of the particles contained in an upstream-side treatment layer.

8. The water treatment apparatus according to claim 7, wherein
a first treatment layer and a second treatment layer are provided in order from the upstream side, and first particles contained in said first treatment layer are mainly composed of a high-molecular compound, and second particles contained in said second treatment layer are mainly composed of diatomite.

9. The water treatment apparatus according to claim 8, wherein
an intermediate treatment layer is further provided between said first treatment layer and said second treatment layer, and intermediate particles contained in said intermediate treatment layer are mainly composed of a high-molecular compound.

10. The water treatment apparatus according to claim 1, wherein
said liquid to be treated includes an oil and a suspended substance, and said oil and said suspended substance are separated from said liquid to be treated.

11. A water treatment method comprising a step of supplying a liquid to be treated to the water treatment apparatus as recited in claim 1, and recovering a treated liquid.
